(19) United States
(12) Patent Application Publication
(10) Pub. No.: US 2006/0078187 A1
(43) Pub. Date: Apr. 13, 2006

(54) Multi-layer electronic component aggregate board and multi-layer electronic component fabricating method

(76) Inventors: Kazuo Kudoh, Tokyo (JP); Minoru Hirasawa, Tokyo (JP); Yoshihiro Suzuki, Tokyo (JP); Tomohiko Kaneyuki, Tokyo (JP); Takeshi Endo, Tokyo (JP)

Correspondence Address: WOLFF LAW OFFICES, PLLC, 209 Providence Road, Chapel Hill, NC, 27514, US

(21) Appl. No.: 11/183,893

(22) Filed: Jul. 19, 2005

(30) Foreign Application Priority Data
Jul. 21, 2004 (JP) 2004-212496

(51) Int. Cl. G06K 9/00

(52) U.S. Cl. 382/145

(57) ABSTRACT

A multi-layer electronic components aggregate board according to the present invention is a multi-layer electronic components aggregate board which enables extracting plural multi-layer electronic components by cutting and includes a trimming pattern 122b formed on a predetermined insulation layer out of plural insulation layers and recognition marks formed on the same insulation layer, the recognition marks indicating the relative positional relationship with respect to the trimming pattern 122b. This enables specifying the trimming position with an extremely simple process, even in the case of specifying the trimming position through image recognition. Furthermore, since the recognition marks and the trimming pattern are formed on the same layer, it is possible to prevent the occurrence of pattern deviation among layers, thus enabling specifying the trimming position with high accuracy.

### TECHNICAL FIELD

The present invention relates to a multi-layer electronic component aggregate board and a multi-layer electronic component fabricating method and, more particularly, to an aggregate board constituted by multi-layer electronic components which require trimming for adjustments of characteristics and a fabricating method of such multi-layer electronic components.

### BACKGROUND OF THE INVENTION

Some multi-layer electronic components such as voltage-controlled oscillators (VCOs) require trimming for changing inductance or capacitance to adjust characteristics after the fabrication of the aggregate boards (refer to Japanese Patent Application Laid-Open (JP-A) Nos. 11-127031, 10-93342 and 11-214925). In general, the trimming is performed by applying a laser beam to trimming patterns to cut a portion thereof and, therefore, it is necessary to specify the trimming positions with the highest possible accuracy. Therefore, conventionally, it has been a common practice to perform trimming concurrently with image recognition for the trimming patterns or to perform trimming concurrently with referring to recognition marks.

However, the trimming method using image recognition of trimming patterns may require complicated image processing, thus inducing the problem of large consumption of time for processing or degradation of the recognition accuracy, in the case where the trimming patterns and peripheral pattern shapes are complicated. Further, the method which refers to recognition marks has the possibility of causing inaccurate specification of the trimming positions due to pattern deviations among layers, in the case where the recognition marks and the trimming patterns are formed in different layers.

### SUMMARY OF THE INVENTION

Consequently, it is an object of the present invention to provide a multi-layer electronic component aggregate board and a multi-layer electronic component fabricating method which enable easily specifying trimming positions with high accuracy.

A multi-layer electronic component aggregate board according to the present invention is a multi-layer electronic component aggregate board which enables extracting a plurality of multi-layer electronic components by cutting and includes a plurality of insulation layers, trimming patterns formed on a predetermined insulation layer out of the plurality of insulation layers and recognition marks formed on the predetermined insulation layer, the recognition marks indicating the relative positional relationship with respect to the trimming patterns.

With the present invention, since there are provided the recognition marks indicating the relative positional relationship with respect to the trimming patterns, it is possible to specify the trimming positions with an extremely simple process, even in the case of specifying the trimming positions through image recognition. Furthermore, since the recognition marks and the trimming patterns are formed on the same layer, it is possible to prevent the occurrence of pattern deviations among layers, thus enabling specifying the trimming positions with high accuracy. This enables easily and accurately performing adjustments of the characteristics of multi-layer electronic components which require trimming, as typified by voltage-controlled oscillators. The trimming patterns may be patterns which enable varying the inductance or the capacitance of themselves by trimming.

Preferably, the recognition marks are made of conductors formed on the predetermined insulation layer. In this case, the trimming patterns and the recognition marks may be concurrently formed with a single process, which may prevent the occurrence of pattern deviations in principle, thus enabling specifying the trimming positions with extremely high accuracy.

Preferably, the predetermined insulation layer is an internal insulation layer which is covered at its both sides with other insulation layers. In this case, the trimming patterns will not occupy the component mounting surfaces of the multi-layer electronic components, thus enabling reduction of two-dimensional sizes of the multi-layer electronic components.

Out of the plurality of insulation layers, the insulation layers covering the recognition marks are preferably exposed at least at the regions lying over the recognition marks. This enables visually recognizing the recognition marks with high clarity, through the insulation layers.

Preferably, the recognition marks are arranged in the cutting allowance regions for enabling extraction of the plurality of multi-layer electronic components by cutting. In this case, the recognition marks will not occupy the effective areas at all, thus enabling reduction of the two-dimensional sizes of the multi-layer electronic components.

Further, a multi-layer electronic component fabricating method according to the present invention includes an aggregate board fabricating process for fabricating an aggregate board including a plurality of multi-layer electronic components, a trimming process for applying trimming to trimming patterns provided in the respective multi-layer electronic components for adjusting the characteristics of the plurality of multi-layer electronic components, and a cutting process for cutting the aggregate board for extracting the plurality of multi-layer electronic components, in the trimming process, the trimming positions are specified by using recognition marks formed on the same plane as the trimming patterns.

The present invention also enables easily adjusting the characteristics of multi-layer electronic components with high accuracy. Further, since the recognition marks have a substantially fixed relative positional relationship with the trimming patterns, it is possible to expect the required amount of trimming for providing desired characteristics with respect to the recognition marks as a reference, by determining the characteristics of the multi-layer electronic components before trimming. This can eliminate the necessity of performing trimming concurrently with determination of the characteristics, thus enabling provision of desired characteristics by performing the amount of trimming determined as a calculated value.

Preferably, the aggregate board fabricating process includes a process for forming the trimming patterns and the recognition marks on a predetermined insulation layer with a single process. This can also prevent the occurrence of pattern deviations in principle, thus enabling specification of the trimming positions with extremely high accuracy.

Preferably, the aggregate board fabricating process further includes a process for forming another insulation layer covering the trimming patterns and the recognition marks. This can also prevent the trimming patterns from occupying the component mounting surfaces of the multi-layer electronic components, thus enabling reduction of the two-dimensional sizes of the multi-layer electronic components. In this case, in the trimming process, the trimming is performed by applying a laser beam from said another insulation layers side with respect to the predetermined insulation layer.

Preferably, the aggregate board fabricating process further includes a process for forming a conductor layer on the another insulation layer, said conductor layer covering at least a part of a regions lying over the trimming patterns such that at least a regions of a surface of the another insulation layer which lie over the recognition marks are exposed. This enables visually recognizing the recognition marks with high clarity, through the insulation layers.

Preferably, in the cutting process, the aggregate board is cut along the recognition marks for extracting the plurality of multi-layer electronic components. In this case, the recognition marks will not occupy the effective areas at all, thus enabling reduction of the two-dimensional sizes of the multi-layer electronic components.

As described above, the present invention enables easily specifying the trimming positions with high accuracy.

### BRIEF DESCRIPTION OF THE DRAWINGS

FIG. 1 is a schematic perspective view illustrating the construction of a multi-layer electronic components aggregate board 10 according to a preferred embodiment of the present invention.

FIG. 2 is a schematic cross sectional view schematically illustrating the construction of the multi-layer electronic component 100.

FIG. 3 is a schematic plan view illustrating the region 10a illustrated in FIG. 1 from the mounting surface 100a side in an enlarged manner.

FIG. 4 is a schematic plan view illustrating the main pattern shapes in the conductor layer 122 in an enlarged manner.

FIG. 5 is a flow chart illustrating a fabricating method of the multi-layer electronic component 100 according to a preferred embodiment of the present invention.

FIG. 6 is a view illustrating a method for specifying the position to be subjected to trimming.

FIGS. 7A to 7D are schematic plan views illustrating various pattern shapes usable as the recognition marks 122a, FIG. 7A illustrating an L-shaped pattern, FIG. 7B illustrating a round-shaped pattern, FIG. 7C illustrating a rectangular-shaped pattern and FIG. 7D illustrating a pattern having a rectangular outside shape with a hollow cross shape inside thereof.

FIG. 8 is a view illustrating an example of trimming by applying a laser beam L from the component mounting surface 100b side.

### DETAILED DESCRIPTION OF THE EMBODIMENTS

Preferred embodiments of the present invention will now be explained in detail with reference to the drawings.

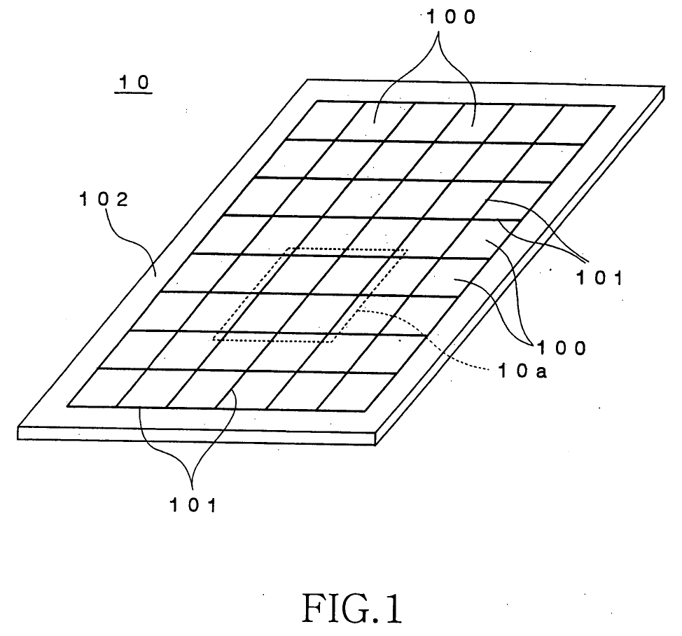

FIG. 1 is a schematic perspective view illustrating the construction of a multi-layer electronic components aggregate board 10 according to a preferred embodiment of the present invention.

As illustrated in FIG. 1, a multi-layer electronic component aggregate board 10 according to the present embodiment is constituted by a plurality of multi-layer electronic components 100 which are arranged in a matrix shape, cutting allowance regions 101 existing around the respective multi-layer electronic components 100, and a frame body 102 surrounding the multi-layer electronic components 100 which are arranged in a matrix shape. The aggregate board 10 illustrated in FIG. 1 is fabricated by an aggregate board fabricating process which will be described later and then the aggregate board 10 is cut along the cutting allowance regions 101 to enable extracting the respective multi-layer electronic components 100. The respective multi-layer electronic components 100 are multi-layer electronic components which require trimming for adjusting inductance and capacitance and are preferably voltage controlled oscillators (VCOs) , but are not particularly limited thereto.

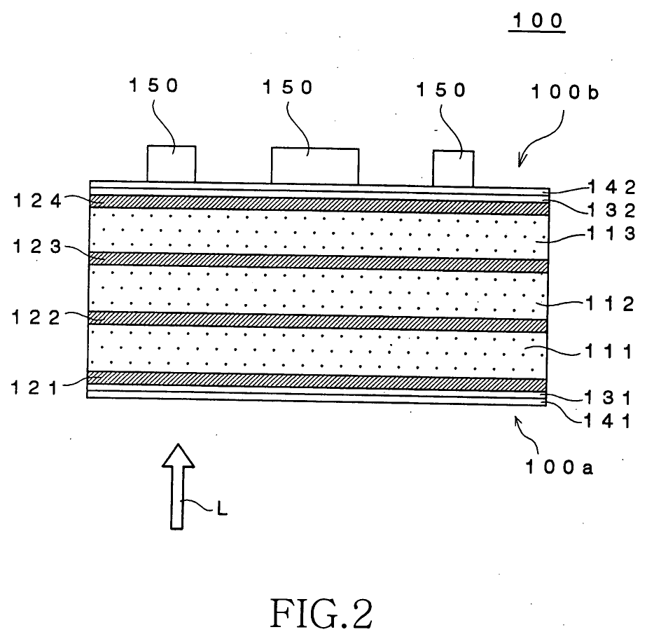

FIG. 2 is a schematic cross sectional view schematically illustrating the construction of the multi-layer electronic component 100.

As illustrated in FIG. 2, a multi-layer electronic component 100 is constituted by a plurality of insulation layers 111 to 113, conductor layers 121 to 124 provided on the surfaces of the respective insulation layers, a plated layer 131 and a resist layer 141 covering the lowermost conductor layer 121 which forms a mounting surface 100a to be placed onto a printed circuit board (not shown) , a plated layer 132 and a resist layer 142 covering the uppermost conductor layer 124 which forms a component mounting surface 100b, and chip components 150 such as capacitors and transistors mounted on the component mounting surface 100b. The materials of the insulation layers 111 to 113 may be insulating resins such as epoxy resins and phenol resins and, preferably, the thickness thereof are set to within the range of about 30 micrometers to 200 micrometers, although they are not particularly limited thereto. While the present embodiment employs materials having high transparencies as the materials of all the insulation layers 111 to 113, it is preferable to employ a material with the highest possible transparency as at least the insulation layer 111.

Further, metal materials such as copper (Cu) may be employed as the materials of the conductor layers 121 to 124 and thickness are preferably set to within the range of about 10 micrometers to 20 micrometers. Further, the lowermost conductor layer 121 forming the mounting surface 100a is a ground pattern and generally covers the most portion of the insulation layer 111, although it is not particularly limited thereto.

A trimming pattern is formed in the conductor layer 122 and a laser beam L will be applied thereto from the mounting surface 100a side for trimming, which will be described in more detail later. Namely, with the present embodiment, the trimming pattern is not provided on the component mounting surface 100b (conductor layer 124) , and an internal pattern on the internal insulation layer 112 which is covered at its both sides with the other insulation layers 111 and 113 constitutes the trimming pattern. Although in general multi-layer electronic components of this type include trimming patterns provided on component mounting surface (refer to Japanese Patent Application Laid-Open (JP-A) Nos. 11-127031 and 10-93342), if a trimming pattern is provided on the component mounting surface 100b, this will increase a two-dimensional size of the multi-layer electronic component, since various types of chip components are mounted on the component mounting surface 100b as previously described. In view of this point, the multi-layer electronic components 100 according to the present embodiment include trimming patterns provided in internal conductor layers 122.

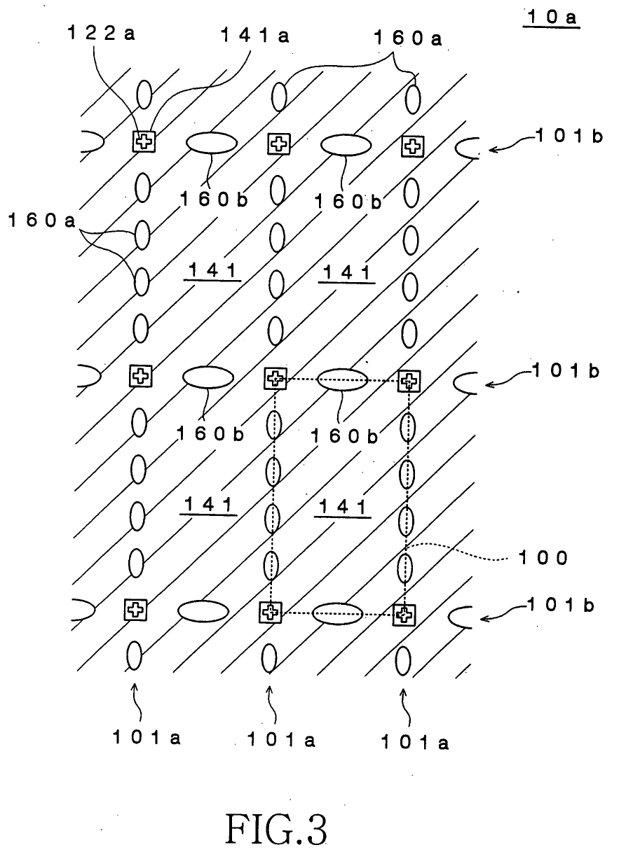

FIG. 3 is a schematic plan view illustrating the region 10a illustrated in FIG. 1 from the mounting surface 100a side in an enlarged manner.

As illustrated in FIG. 3, the aggregate board 10 according to the present embodiment is provided with a plurality of through holes 160a extending in a single direction and a plurality of through holes 160b extending in the direction orthogonal to the direction of the through holes 160a. Conductors which are not illustrated are formed on the inner walls of these through holes 160a and 160b. The regions along the through holes 160a and 160b are cutting allowance regions 101a and 101b and, by cutting the aggregate board 10 along the cutting allowance regions 101a and 101b, portions of the conductors formed on the inner walls of the through holes 160a and 160b are exposed to the surfaces to form external electrodes. In FIG. 3, a region which forms a single multi-layer electronic component 100 after cutting is indicated by a broken line.

While most portions of the mounting surfaces 100a of the respective multi-layer electronic components 100 are covered with the resist layer 141 as illustrated in FIG. 3, the regions at the intersections of the cutting allowance regions 101a and the cutting allowance regions 101b are not covered with the resist layer 141 and also not covered with the conductor layer 121 and the plated layer 131 illustrated in FIG. 2, and therefore the insulation layer 111 is exposed thereat. Since the insulation layer 111 has transparency to light, it is possible to visually recognize the conductor layer 122 through the insulation layer 111. The portions of the conductor layer 122 which correspond to the regions 141a are provided with cross-shaped recognition marks 122a and, as illustrated in FIG. 3, the cross-shaped recognition marks 122a can be visually recognized through the regions 141a. These recognition marks 122a indicate the relative positional relationship with respect to the trimming patterns formed in the same conductor layer 122 and therefore are used for specifying the positions of the trimming patterns.

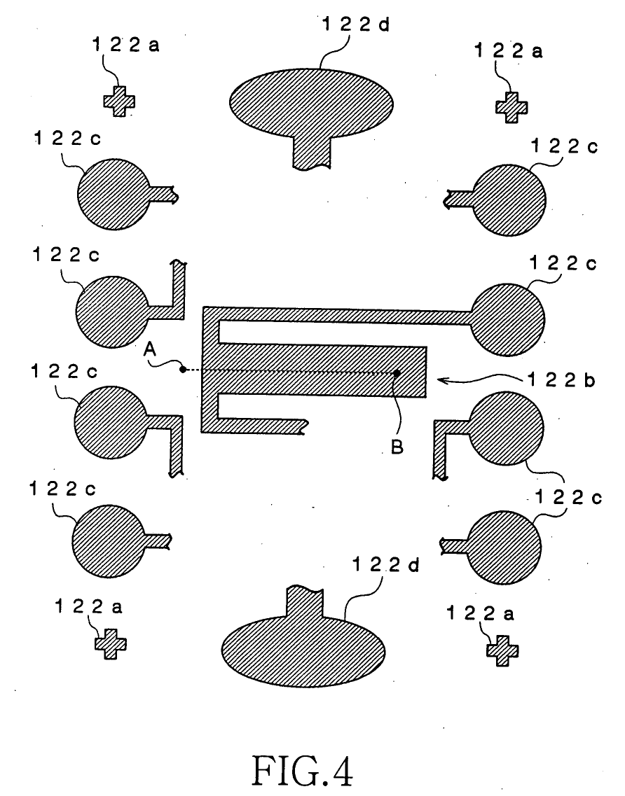

FIG. 4 is a schematic plan view illustrating the main pattern shapes in the conductor layer 122 in an enlarged manner.

As illustrated in FIG. 4, the conductor layer 122 includes the recognition marks 122a and the trimming patterns 122b and, further, electrode patterns 122c and 122d are provided respectively at the regions over which the through holes 160a and 160b are to be formed. As described above, the recognition marks 122a and the trimming patterns 122b are constituted by the same conductor layer (122) and, therefore, the recognition marks 122a and the trimming pattern 122b may be concurrently formed with a single process. Although the method for forming the conductor layer 122 is not particularly limited, a subtractive process, an additive process, a semi-additive process, a screen printing process, etc., may be employed and the utilization of any of these processes enables forming them concurrently, thus substantially preventing the occurrence of deviations in the relative positional relationship therebetween.

In the present embodiment, the trimming pattern 122b constitutes a pattern which enables adjusting the inductance of itself by trimming and, by cutting the trimming pattern 122b by a certain length from a point A to a point B illustrated in FIG. 4, the wiring length can be changed, thus changing the inductance.

Hereinbefore, there has been described the structure of the multi-layer electrode components aggregate board 10 according to the present embodiment. Next, there will be described a method for fabricating multi-layer electronic components according to a preferred embodiment of the present invention.

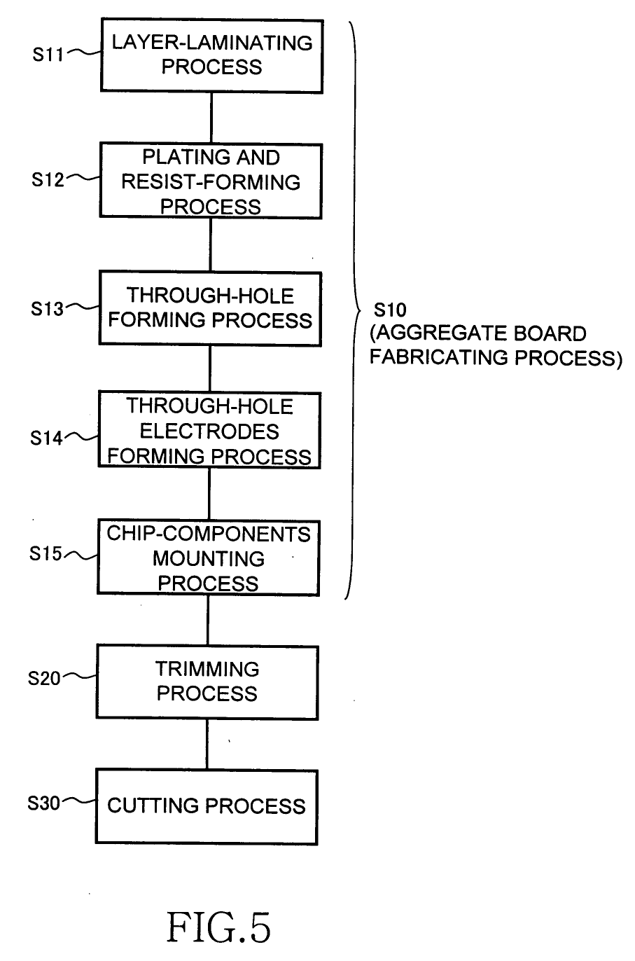

FIG. 5 is a flow chart illustrating a fabricating method of the multi-layer electronic component 100 according to a preferred embodiment of the present invention.

At first, a multi-layer electronic component aggregate board 10 as mentioned above is fabricated with an aggregate board fabricating process (step S10). The aggregate board fabricating process includes a layer-laminating process (step S11) for forming and laminating conductor layers 121 to 124 on the surfaces of the insulation layers 111 to 113, a plating and resist-forming process (step S12) for forming the plated layer 131 and the resist layer 141 covering the lowermost conductor layer 121 and for forming the plated layer 132 and the resist layer 142 covering the uppermost conductor layer 124, a through-hole forming process (step S13) for forming the through holes 160a and 160b, a through-hole electrodes forming process (step S14) for forming the conductors on the inner walls of the through holes 160a and 160b, and a chip-components mounting process (step S15) for mounting the chip components 150 on the component mounting surface 100b.

It is preferable that the layer-laminating process (step S11) includes a process for forming the conductor layers 122 and 123 on the surfaces of the insulation layer 112 which forms a core board, subsequently sandwiching them between prepregs made of uncured resin or semi-cured resin and then curing the prepregs through hot pressing to form the insulation layers 111 and 113, although the layer-laminating process is not limited thereto. In this case, the layer-laminating process includes a process for forming the patterns illustrated in FIG. 4 on the surface of the insulation layer 112 serving as the core board and, since the recognition marks 122a and the trimming patterns 122b can be concurrently formed with a single process as previously described, there will be hardly induced deviations in the relative positional relationship therebetween.

As previously described, the conductor layer 121 formed on the surface of the insulation layer 111 is generally a ground pattern. Therefore, the conductor layer 121 is formed to cover the most portion of the insulation layer 111. Thus, the conductor layer 121 covers a portion or all of the regions lying over the trimming patterns 122b. In this case, although a portion or all of the trimming patterns 122b can not be visually recognized from the mounting surface 100a side, the conductor layer 121 is formed not to cover at least the regions lying over the recognition marks 122a, which enables visually recognizing the recognition marks 122a from the mounting surface 100a side. In the plating and resist-forming process (step S12), the resist layer 141 is formed such that the regions of the surface of the insulation layer 111 which lie over the recognition marks 122a are exposed.

When the fabrication of the multi-layer electronic component aggregate board 10 has been completed as described above, then adjustments of characteristics of the respective multi-layer electronic components 100 are performed in the trimming process (step S20). In the trimming process, as illustrated in FIG. 2, a laser beam L is applied from the mounting surface 100a side for performing trimming. The trimming is performed by cutting the trimming pattern 122b by applying the laser beam and, since the conductor layer 122 is a layer inside of the board as previously described, there exist the other conductor layer 111, the plated layer 131 and the resist layer 141 along the direction of the irradiation of the laser beam. Therefore, the trimming pattern 122b can not be directly recognized through visual recognition or image recognition. However, the conductor layer 122 includes the recognition marks 122a indicating the relative positional relationship with respect to the trimming pattern 122b and they can be recognized from the mounting surface 100a side, thus enabling specifying the trimming position by using the recognition marks 122a as a reference.

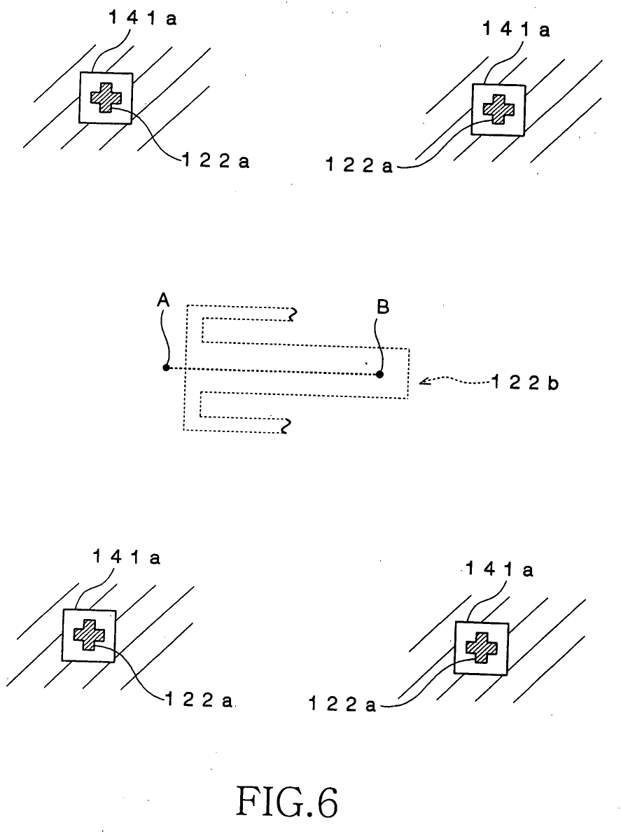

Namely, by grasping in advance the relative positional relationship between the recognition marks 122a and the trimming pattern 122b, it is possible to specify the position to be subjected to trimming by referring to the recognition marks 122a which are visible through the regions 141a by visual recognition or image recognition, although actually the trimming pattern 122b can not be viewed from the mounting surface 100a side as illustrated in FIG. 6 (there is illustrated, in FIG. 6, the unviewable pattern by a broken line). Consequently, by starting the irradiation of the laser beam L at the point A as a starting point and gradually displacing the irradiated position toward the point B under a condition where the probes are in contact with the conductors within the through holes 160a and 160b shown in FIG. 3 and the multi-layer electronic component 100 is actually operated, the inductance can be gradually changed, thus gradually changing the characteristics of the multi-layer electronic component 100 (the relationship between the controlling voltage and the oscillation frequency, in the case where the multi-layer electronic component 100 is a VCO). Further, by terminating the trimming at the time desired characteristics have been obtained, the adjustment of the multi-layer electronic component 100 can be completed.

Also, by determining in advance the relationship between the amount of trimming and the amount of characteristics change and then defining the relationship as a mathematical expression or a table, instead of performing trimming concurrently with determination of the characteristics, it is possible to easily determine the required amount of trimming only by determining the characteristics of the multi-layer electronic component 100 before trimming. In this case, it is not necessary to perform trimming concurrently with determination of characteristics and it is possible to provide desired characteristics by performing the amount of trimming determined as a calculated value. In this case, similarly, it is possible to set the amount of trimming using the recognition marks 122a as a reference, thus performing accurate amounts of trimming.

Then, after performing such trimming to the respective multi-layer electronic components 100, the aggregate board 10 is cut along the cutting allowance regions 101a, 101b in the cutting process (step S30) to enable extracting the multi-layer electronic components 100 which have been subjected to the characteristics adjustments.

As described above, with the present embodiment, since there are provided, in the aggregate board 10, the recognition marks 122a indicating the relative positional relationship with respect to the trimming patterns 122b, it is possible to specify the trimming positions with significantly simple processes even in the case of specifying the trimming positions through image recognition. Furthermore, since the recognition marks 122a are conductor layers formed on the layer on which the trimming patterns 122b are formed, they can be concurrently formed with a single process. This can prevent the occurrence of pattern deviations therebetween in principle, thus enabling specifying the trimming positions with extremely high accuracy.

Further, with the present embodiment, since the trimming patterns 122b are provided in the internal conductor layer 122, the trimming patterns do not occupy the component mounting surfaces 100b, thus enabling reduction of two-dimensional sizes of the multi-layer electronic components 100. Furthermore, with the present embodiment, since the recognition marks 122a are arranged along the cutting allowance regions 101a and 101b, the recognition marks. 122a do not occupy the effective areas on the aggregate board at all.

Further, if trimming patterns are formed on the mounting surface 100a, the conductor constituting the trimming patterns will be dispersed therearound during trimming thus inducing short-circuit malfunctions. However, with the present embodiment, the trimming patterns 122b are provided in the internal conductor layer 122, thus preventing the occurrence of such a problem.

Further, by providing the trimming patterns 122b in the internal conductor layer 122 as in the present embodiment, the trimming patterns 122b are covered at its both sides with the insulation layer 111 and the insulation layer 112 thus providing more stable electrical characteristics than the case of forming the trimming patterns on the mounting surface 100a.

As described above, the present embodiment enables easily specifying the trimming positions with high accuracy and also enables miniaturization of the completed multi-layer electronic components 100.

The present invention is not limited to the embodiment and various modifications may be made without departing from the scope of the present invention defined in the claims. It goes without saying that such modifications are also included in the scope of the present invention.

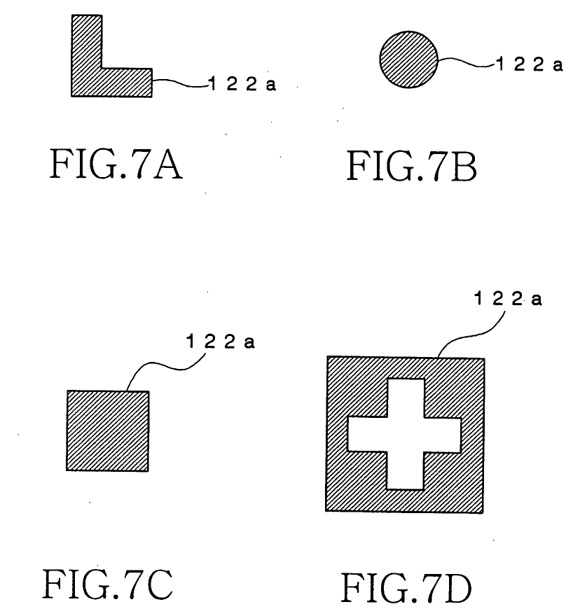

For example, while the embodiment employs cross-shaped patterns as the recognition marks 122a, the recognition marks 122a are not limited thereto and may be any patterns indicative of the relative positional relationship with respect to the trimming patterns 122b. Therefore, they may be L-shaped patterns as illustrated in FIG. 7A, round-shaped patterns as illustrated in FIG. 7B, rectangular-shaped patterns as illustrated in FIG. 7C or patterns having a rectangular outside shape with a hollow cross shape inside thereof as illustrated in FIG. 7D.

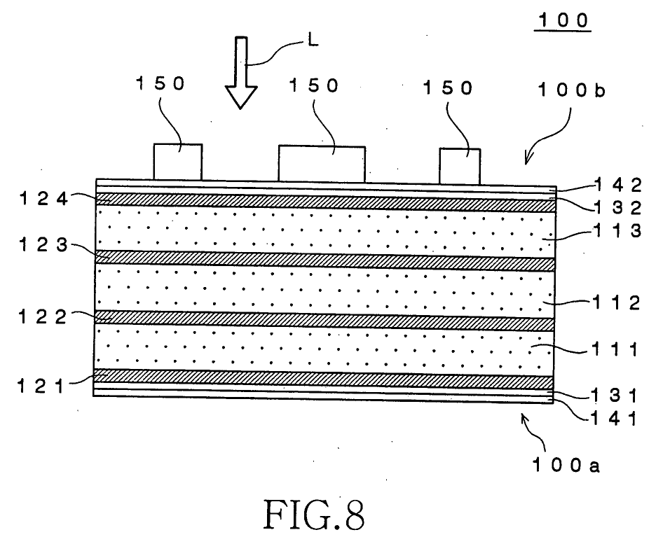

Further, while the embodiment performs trimming by applying a laser beam L from the mounting surface 100a side, the trimming may be performed by applying a laser beam L from the component mounting surface 100b side as illustrated in FIG. 8. In order to embed a trimming pattern in the example of FIG. 8, the trimming pattern and recognition marks may be provided in the second conductor layer 123 from the component mounting surface 100b. Further, it is not necessary that the direction of visual recognition of the recognition marks is coincident with the direction of irradiation of the laser beam L and, for example, the recognition marks may be visually recognized from the mounting surface 100a side while the laser beam may be applied from the component mounting surface 100b side.

Further, while the embodiment employs variable-inductance patterns as the trimming patterns 122b, the trimming patterns 122b may be any patterns which enable adjusting the characteristics of the multi-layer electronic components and may be, for example, variable-capacitance patterns.

Further, while in the embodiment the regions 141a are not covered with the conductor layer 121, the plated layer 131 and the resist layer 141 so that the insulation layer 111 is exposed thereat, it is not necessary that the insulation layer 111 is exposed at the regions 141a and the regions 141a may be covered with some layers as long as the recognition marks 122a can be visually recognized.

Further, while the embodiment employs the recognition marks 122a placed at the intersections of the cutting allowance regions 101a and 101b, the positions of the recognition marks are not particularly limited as long as they are formed on the plane surface on which the trimming patterns are formed. However, by placing the recognition marks along at least one of the cutting allowance regions 101a and the cutting allowance regions 101b, it is possible to prevent the recognition marks from occupying the effective areas.

What is claimed is:

1. A multi-layer electronic component aggregate board which enables extracting a plurality of multi-layer electronic components by cutting, comprising:
a plurality of insulation layers;
trimming patterns formed on a predetermined insulation layer out of the plurality of insulation layers; and
recognition marks formed on the predetermined insulation layer,
the recognition marks indicating the relative positional relationship with respect to the trimming patterns.

2. The multi-layer electronic component aggregate board as claimed in claim 1, wherein said recognition marks are made of conductors formed on the predetermined insulation layer.

3. The multi-layer electronic component aggregate board as claimed in claim 1, wherein said predetermined insulation layer is an internal insulation layer which is covered at its both sides with other insulation layers.

4. The multi-layer electronic component aggregate board as claimed in claim 2, wherein said predetermined insulation layer is an internal insulation layer which is covered at its both sides with other insulation layers.

5. The multi-layer electronic component aggregate board as claimed in claim 3, wherein a insulation layer out of the plurality of insulation layers covering the recognition marks are exposed at least at a regions lying over the recognition marks.

6. The multi-layer electronic component aggregate board as claimed in claim 4, wherein a insulation layers out of the plurality of insulation layers covering the recognition marks are exposed at least at a regions lying over the recognition marks.

7. The multi-layer electronic component aggregate board as claimed in claim 1, wherein said recognition marks are arranged in cutting allowance regions for enabling extraction of the plurality of multi-layer electronic components by cutting.

8. The multi-layer electronic component aggregate board as claimed in claim 2, wherein said recognition marks are arranged in cutting allowance regions for enabling extraction of the plurality of multi-layer electronic components by cutting.

9. The multi-layer electronic component aggregate board as claimed in claim 3, wherein said recognition marks are arranged in cutting allowance regions for enabling extraction of the plurality of multi-layer electronic components by cutting.

10. The multi-layer electronic component aggregate board as claimed in claim 5, wherein said recognition marks are arranged in cutting allowance regions for enabling extraction of the plurality of multi-layer electronic components by cutting.

12. The multi-layer electronic component aggregate board as claimed in claim 1, wherein said plurality of multi-layer electronic components are voltage-controlled oscillators.

13. The multi-layer electronic component aggregate board as claimed in claim 1, wherein said trimming patterns are patterns which enable varying at least one of an inductance and a capacitance of themselves by trimming.

14. A multi-layer electronic component fabricating method, comprising:
an aggregate board fabricating process for fabricating an aggregate board including a plurality of multi-layer electronic components;
a trimming process for applying trimming to trimming patterns provided in respective multi-layer electronic components for adjusting a characteristics of the plurality of multi-layer electronic components; and
a cutting process for cutting the aggregate board for extracting the plurality of multi-layer electronic components,
the trimming positions are specified in the trimming process by using recognition marks formed on the same plane as the trimming patterns.

15. The multi-layer electronic component fabricating method as claimed in claim 14, wherein said aggregate board fabricating process includes a process for forming the trimming patterns and the recognition marks on a predetermined insulation layer with a single process.

16. The multi-layer electronic component fabricating method as claimed in claim 15, wherein said aggregate board fabricating process further includes a process for forming another insulation layer covering the trimming patterns and the recognition marks.

17. The multi-layer electronic component fabricating method as claimed in claim 16, wherein said aggregate board fabricating process further includes a process for forming a conductor layer on the another insulation layer, said conductor layer covering at least a part of a regions lying over the trimming patterns such that at least a regions of a surface of the another insulation layer which lie over the recognition marks are exposed.

18. The multi-layer electronic component fabricating method as claimed in claim 16, wherein said trimming process is performed by applying a laser beam from said another insulation layers side with respect to said predetermined insulation layer.

19. The multi-layer electronic component fabricating method as claimed in claim 17, wherein said trimming process is performed by applying a laser beam from said another insulation layers side with respect to said predetermined insulation layer.

20. The multi-layer electronic component fabricating method as claimed in claim 14, wherein said cutting process is performed by cutting the aggregate board along the recognition marks for extracting the plurality of multi-layer electronic components.
